(19) United States
(12) Patent Application Publication
(10) Pub. No.: US 2020/0314406 A1
(43) Pub. Date: Oct. 1, 2020

(54) Device for generating at least one hologram, in particular by means of drones

(71) Applicant: Özgür Geles, Regensburg (DE)

(72) Inventor: Özgür Geles, Regensburg (DE)

(21) Appl. No.: 16/681,540

(22) Filed: Nov. 12, 2019

(30) Foreign Application Priority Data
Mar. 29, 2019 (DE) 10 2019 108 249.8

(51) Int. Cl. H04N 13/189; H04N 13/349

(52) U.S. Cl. CPC H04N 13/189; H04N 13/349

(57) ABSTRACT

A method for generating at least one hologram includes at least one hologram projection device, at least one storage medium on which at least one previously played field game is at least partially stored, and at least one playback element communication with the storage medium for supplying the hologram projection device with data to be projected. The data include at least one data packet containing data of the previously played field game, and includes data of a location and/or time and/or physical condition of at least one game participant as a function of a playing time during a game. Thus, these data can be reproduced by the hologram projection device in real time, in order to reproduce the field game by the hologram.

The present invention relates to a method for generating at least one hologram, in particular for hologram-like presentation of game participants, and to a device for generating at least one hologram, in particular for hologram-like presentation of game participants according to the respective preambles of claims 1 and 9.

Football games have lately become very popular. In particular, football games are reproduced by storage media, which are recorded in particular by video recorders and are displayed on screens, for example, in the context of public viewing. To this end, the interested fans of a game gather in front of a projection screen on which a projector plays the game either live or delayed. However, such presentations are limited in their impact because ultimately the game is rendered in two dimensions.

The present invention therefore solves this deficiency and offers a not only cost-effective, but also technically particularly practical solution in that a football game is reproduced time-delayed in three-dimensional form, in particular in real time.

In this context, “real time” means that the game is repeated as realistically as possible, i.e. on a 1:1 time basis.

For this purpose, the above-proposed method comprises at least one hologram projection device for generating at least one hologram. The hologram projection device may be one which comprises at least one projector which is set up and intended to reproduce a hologram, preferably of a game participant. The hologram is preferably reproduced in a direction that is horizontal, vertical or nearly vertical so as to give a three-dimensional impression of the entire game.

In accordance with at least one embodiment, the method described here comprises at least one storage medium on which at least one previously played football game and/or other playing field game is at least partially stored. In other words, a previously played real football game and/or other real playing field game is/are recorded and then reproduced at any subsequent time, for example, to be analysed by interested viewers. In this respect, the present method for generating at least one hologram not only relates to a live reproduction, but in this respect can also represent a method for the time-delayed reproduction of the hologram.

In accordance with at least one embodiment, the method comprises at least one playback element, which is in data communication with the storage medium and which supplies the hologram projection device with data to be projected.

In this respect, the playback element can represent a central or decentralised server element which forwards the data stored on the memory element to the hologram projection device and/or the playback element can itself represent a control and/or regulating device for individual projectors of the hologram projection device.

According to the invention, the data comprise at least one data packet which contains data of the previously played football game and/or the other playing field game, and these data comprising data of a location and/or a time and/or a physical condition of at least one game participant as a function of a playing time during a game are formed, so that these data are reproduced by the hologram projection device, in particular in real time, to reconstruct the football game and/or the playing field game by means of the hologram, also 1:1 in terms of time.

“Physical condition” in connection with the patent application means, inter alia, a geometric shape and design of the player of the football game and/or the playing field game to be projected.

In other words, in this way the football game can be reproduced completely realistically, for example, 1:1, but also in a reduced size, for example, 1:2, 1:3, 1:4, etc.

In accordance with at least one embodiment, the method for generating at least one hologram, in particular for hologram-like presentation of game participants, comprises at least one hologram projection device for generating at least one hologram and at least one storage medium on which at least one previously played football game and/or another playing field game is at least partially stored. In addition, the method described here comprises at least one playback element which is in data communication with the storage medium and which supplies the hologram projection device with data to be projected.

According to the invention, the data comprise at least one data packet which contains data of the previously played football game and/or the other playing field game and these data comprising data of a location and/or a time and/or a physical condition of at least one game participant as a function of a playing time during a game are formed, so that these data are reproduced by the hologram projection device, in particular in real time, to reconstruct the football game and/or the playing field game by means of the hologram.

In accordance with at least one embodiment, the hologram projection device comprises at least one projector, preferably a plurality of projectors, wherein the projector is assigned to at least one small game participant, preferably uniquely, preferably biuniquely, and represents him over at least part of the game time by generating the hologram.

In other words, therefore, a game participant can be represented separately or together with a plurality of players, in particular together with the entire dynamic movement system of a game team.

In accordance with at least one embodiment, the plurality of projectors of the hologram projection device are arranged in the form of rows and columns, that is to say in a matrix-like manner above and/or below the playing field. The projectors can be controlled according to the game play by the playback element, so that each projector reproduces a hologram or two or more projectors reproduce, by radiation interference, at least one game participant, i.e. a hologram.

In accordance with at least one embodiment, at least one projector can be moved by means of a drone. For example, several of the projectors are each attached to one or more drones. A drone in the sense of the invention is an unmanned vehicle (also a drone) and in general a vehicle without a crew, operated either autonomously or by remote control. For this purpose, the device claimed here may comprise a corresponding controller which controls the drones as a function of the image to be projected. For example, the drones are controlled thereby like a swarm. For example, using the drones, the projectors are controlled and/or controllable as if on rails.

It is also conceivable that a substantially smooth large-screen surface may be considered as a projection surface. For this purpose, it is conceivable that the large-screen surface is designed in the form of a glass and/or plastic surface.

In accordance with at least one embodiment, a main emission direction of the projector is pivotable with respect to a vertical direction.

In this respect, therefore, it can also be considered that the projector not only performs a vertical emission, in particular relative to the ground surface of the playing field, but the players can also be displayed in a certain inclination relative to each other.

In accordance with at least one embodiment, a pivot angle of the projector is pivotable by at least 10°, preferably by at least 20°.

Furthermore, the present invention relates to a device for generating at least one hologram, in particular for hologram-like presentation of game participants.

That is, for the device described here, all features disclosed for the previously described method are disclosed, and vice versa.

In accordance with at least one embodiment, the device for generating at least one hologram, in particular for hologram-like presentation of game participants, comprises at least one hologram projection device for generating at least one hologram.

In addition, the device comprises at least one storage medium on which at least one previously played football game and/or other playing field game are at least partially stored. In addition, the device comprises at least one playback element which is in data communication with the storage medium and which supplies the hologram projection device with data to be projected.

According to the invention, the data comprise at least one data packet which contains data of the previously played football game and/or the other playing field game and these data comprising data of a location and/or a time and/or a physical condition of at least one game participant as a function of a playing time during a game are formed, so that these data can be reproduced by the hologram projection device, in particular in real time, to reconstruct the football game and/or the playing field game by means of the hologram.

In this case, the present device has the same advantageous embodiments as the method described above.

In the following, the method described above as well as the device described above will be described in more detail with reference to an embodiment of a figure.

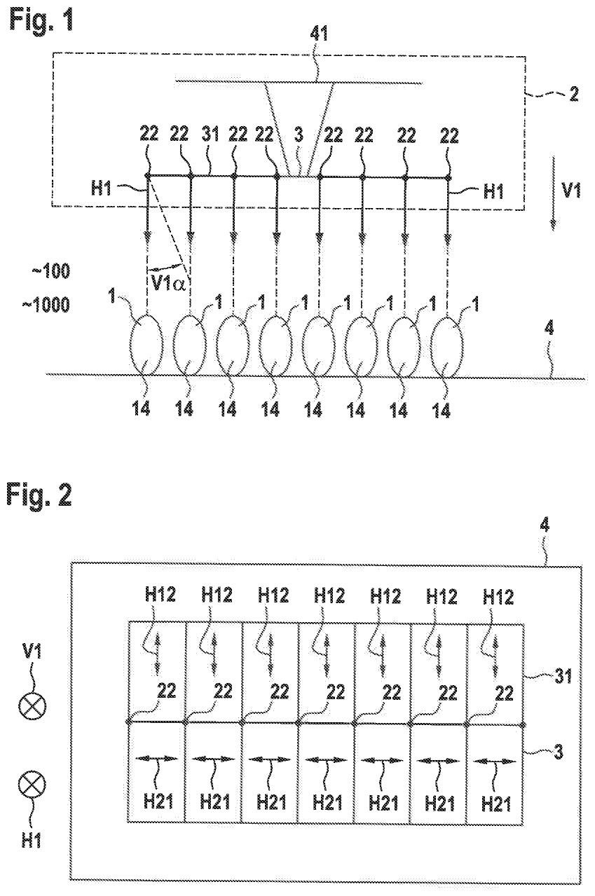

In this case, FIG. 1 shows a side view of a real playing field, above which a rail system is arranged with corresponding projectors, which emit in the direction of the ground surface of the playing field.

FIG. 2 shows a corresponding top view of FIG. 1.

Identical or equivalent components of the figures are also provided with the same reference signs. As can be seen from FIG. 1, there is shown a device 1000 for generating at least one hologram 1, in particular for hologram-like presentation of game participants 14.

A hologram projection device 2 having a plurality of projectors 22 arranged above the playing field 4 can be recognised. Each of the projectors 22 may be associated with a game participant 14.

In particular, the projectors 22 are arranged on a rail system 3 above the playing field 4, the projectors 22 in the present case being displaceable along the rail system 3. For this purpose, a respective motor element can be arranged on the rail system 3 and associated with each projector 22, and can move the respective projectors 22 along the rails 31 as a function of the respective position of the individual game participants 14.

In addition, it is shown that the rail system 3 is arranged on a support 41, so that the rail system 3 is mounted practically hovering over the playing field 4.

Each of the projectors 22 has a main emission direction H1, which in the present case is pivotable relative to a vertical direction V1 by a pivot angle V1α.

FIG. 2 shows the corresponding top view, with the rail elements 31 of the rail system 3 arranged in a matrix-like manner being shown particularly clearly. For this purpose, the individual projectors 22 in the present case are arranged along nodes, in particular at nodes.

According to the respective position of the individual players, in the present case one projector 22 is assigned to a single game participant 14, and by means of individual motor elements and by activation of the respective playback element, the individual projectors 22 can also move outside of these nodes and are moved away from these nodes in arrow directions H12, H21 (the directions are perpendicular to each other).

The applicant reserves the right to claim all features disclosed in the application documents as essential to the invention, provided that these are novel individually and in combination with respect to the prior art.

### LIST OF REFERENCE SIGNS

1 hologram
2 hologram projection device
3 rail system
4 playing field
14 game participants
22 projectors
31 rails
41 support
100 method
1000 device
H1 main emission direction
H12 arrow direction
H21 arrow direction
V1 vertical direction
V1α pivot angle

1. A method for generating at least one hologram, in particular for hologram-like presentation of game participants, comprising
at least one hologram projection device for generating at least one hologram,
at least one storage medium on which at least one previously played football game and/or another playing field game is at least partially stored,
at least one playback element which is in data communication with the storage medium and which supplies the hologram projection device with data to be projected, wherein
the data comprise at least one data packet containing data of the previously played football game and/or the other playing field game, and this data comprising data of a location and/or a time and/or a physical condition of at least one game participant as a function of a playing time are formed during a game, so that these data are reproduced by the hologram projection device, in particular in real time, to reproduce the football game and/or the playing field game by the hologram.

2. The method according to claim 1,
wherein
the hologram projection device comprises at least one projector, preferably a plurality of projectors, wherein the projector is assigned to at least one game participant and represents him over at least part of the playing time by generating the hologram.

3. The method according to claim 1, wherein
the plurality of projectors of the hologram projection device are arranged in the form of rows and columns, i.e. in the form of a matrix, above and/or below the playing field, and are controlled by the playback element in accordance with the course of the game, so that each projector reproduces a hologram or two or more projectors reproduce, by radiation interference, at least one game participant.

4. The method according to claim 1, wherein
a main emission direction (H1) of the projector is pivotable with respect to a vertical direction (V1).

5. The method according to claim 1, wherein
a pivot angle (V1α) of the projector is at least 10 degrees, preferably at least 20 degrees.

6. A device for generating at least one hologram, in particular for hologram-like presentation of game participants, comprising
at least one hologram projection device for generating at least one hologram,
at least one storage medium on which at least one previously played football game and/or another playing field game is at least partially stored,
at least one playback element which is in data communication with the storage medium and which supplies the hologram projection device with data to be projected, wherein
the data comprise at least one data packet containing data of the previously played football game and/or the other playing field game, and these data comprising data of a location and/or a time and/or a physical condition of at least one game participant (14) as a function of a playing time are formed during a game, so that these data can be reproduced by the hologram projection device, in particular in real time, in order to reproduce the football game and/or the playing field game by the hologram.
